(19) United States
(12) Patent Application Publication
(10) Pub. No.: US 2023/0298090 A1
(43) Pub. Date: Sep. 21, 2023

(54) SYSTEM AND METHOD FOR ONLINE ORDERING

(71) Applicant: Ikabit, Inc., Folsom, CA (US)

(72) Inventor: Divya Anantharaman, Folsom, CA (US)

(73) Assignee: Ikabit, Inc., Folsom, CA (US)

(21) Appl. No.: 18/122,117

(22) Filed: Mar. 15, 2023

Related U.S. Application Data
(60) Provisional application No. 63/320,192, filed on Mar. 15, 2022.

(51) Int. Cl. G06Q 30/0601; G06Q 50/12

(52) U.S. Cl. CPC G06Q 30/0641; G06Q 50/12

(57) ABSTRACT

Disclosed is a wireless system and method that enables restaurants to input their menu and other information and enables customers to order food on the computerized application and process these orders on a restaurant personnel smartphone application. In certain embodiments of the disclosed system and method, restaurants pay a monthly subscription fee and agree not to increase their menu prices for orders placed through this application.

### PRIORITY CLAIM

This application claims the benefit of U.S. Provisional Application No. 63/320,192, filed on Mar. 15, 2022. The aforementioned application is incorporated herein by reference.

### BACKGROUND

When customers order food from food delivery applications (FDA), most FDA's charge the restaurant a combination of fees like initiation fee, monthly fees, flat percentage on each check, service fees etc. Since it is not advantageous for the restaurants to bear these fees, they in turn increase their menu prices to compensate for the fees that the FDAs charge, these fees are sometimes as high as 91%, but usually in the range of 30-40%, which is borne by customers using these services, along with any additional service fees, taxes, delivery fees and gratuity.

In contrast to existing FDA's the disclosed cloud-based web application enables restaurants to input their menu and other information and enables customers to order food on the computerized application and process these orders on a restaurant personnel smartphone application.

### BRIEF SUMMARY

Disclosed is a system and method that enables restaurants to input their menu and other information and enables customers to order food on the computerized application and process these orders on a restaurant personnel smartphone application. In certain embodiments of the disclosed system and method, restaurants pay a monthly subscription fee and agree not to increase their menu prices for orders placed through this app.

Certain embodiments of the customer application are built to allow users to include up to eight selected restaurants customers can customize and save their orders and dishes. Other applications allow a user to select an unlimited number of restaurants, or other vendors or retailers.

Other embodiments of the disclosed system enable users to provide home cooked meals to customers.

### FIGURES

FIG. 1 illustrates a representative embodiment of a wireless, computerized system through which users may order food from restaurants and restaurants may sell items to users.

FIG. 2 illustrates a representative embodiment of a system, wherein a user pays a subscription fee to use the system.

FIG. 3 illustrates a representative embodiment of a workflow used by restaurant personnel to establish a restaurant profile on the system.

FIG. 4 illustrates a representative embodiment of a workflow used by a user to order food through the system.

FIG. 5 illustrates a representative embodiment of use of the system by restaurant personnel.

### DETAILED DESCRIPTION

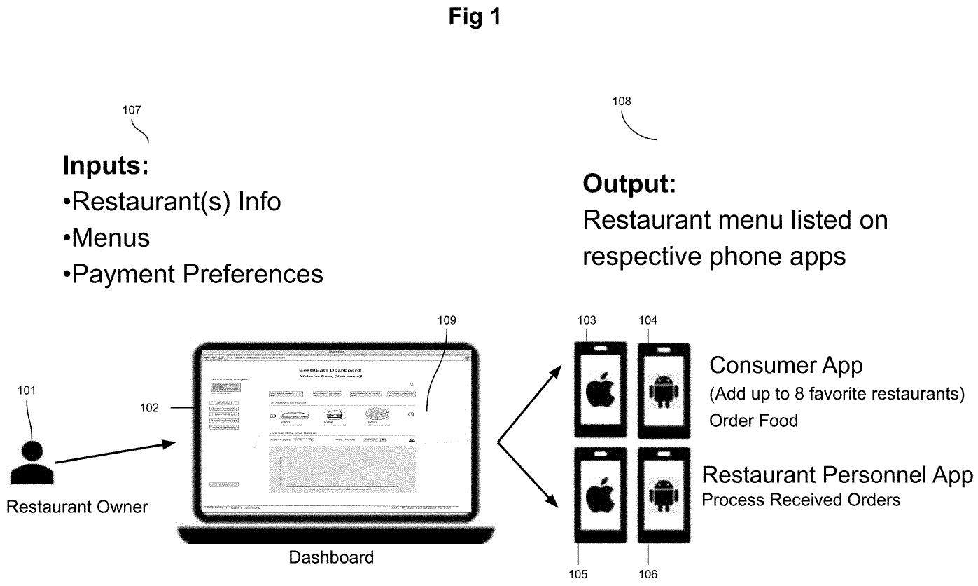

FIG. 1 illustrates an overview of an embodiment of the disclosed system. The disclosed system is a computerized system, through which restaurants can offer items for sale. The restaurants and users access the system through the Internet, or through local networks. Computers, smartphones, and other devices, connected to a network may be used to access the system. Certain embodiments provide a computer application, viewable on a smartphone, tablet, or other computing device. Other embodiments allow access through a web interface, accessed with a web browser or similar software. In this embodiment, the restaurant staff enters the restaurant information, menus, payment preferences, and other data into the software and the menu and information is available immediately on the consumer application for customers to add the restaurant into their list and start ordering food for pickup from there. Each device capable of accessing the system comprises a power source, processor, and display, which may be a monitor or smartphone or table screen. Software encoding the system may be stored on remote server. In certain embodiments, the software encoding instructions for carrying out the methods set forth herein are encoded on non-transitory, computer readable media, coupled to the system. The restaurant personnel 101 can view and process these orders using a device 102 coupled to the system, which may be a computer or smartphone. An interface 109 is displayed to restaurant personnel. Restaurants may provide various inputs 107, which may include information about the restaurant, location, hours, payment options, and other information. Outputs 108 provided by the system include restaurant menus. The user application may be optimized for iOS 103, or Android 106 platforms, and may also be displayed on any device connected to the internet through a browser or similar software. Users may add favorite restaurants, to be displayed on a login screen, or saved to their profiles. Certain embodiments allow users to select and save eight favorite restaurants, but the number of favorite restaurants can vary in different embodiments.

In certain embodiments, dashboard analytics are available on a website, or other computer interface, for the restaurant to obtain data on issues such as restaurants sales for any given period of time, the most popular dishes, reports and graphs to display various performance metrics. The analytics data is provided to the restaurant as a combination of restaurant history and future predictions. Such future predictions may be generated through artificial intelligence. Additionally, predications can be made, based on prior activity, on matters such as staffing needs for restaurants, inventory needs, such as ordering inventory and managing inventory. Any changes made in the restaurant settings are available immediately to the users and the software has functionality to enable use by single restaurants, chain of restaurants with single menu or multiple restaurants under one ownership. The restaurant can set its own payment preferences, policies and order cancellation policies. Restaurants can create custom promo codes and advertise directly to customers through SMS or email and mark their custom holiday calendars. The restaurant can either upload their own menu or request a service provider to create a custom menu by scanning their menu pages and uploading existing menu pages. The restaurants can create any number of menus and subcategories including appetizers, deserts, and beverages. Retreatants can also create alcoholic and nonalcoholic beverage lists that the user can order online. Each dish they add can be customized to include images, main ingredients in the dish, additional descriptions for the dish, different pricing for different portion sizes, additional pricing, and list food sensitivities like gluten, nuts and calories. There are different levels of permission for users, depending on which user needs to access what part of the restaurant information. For example, the bartender can only access the alcohol menu and the manager could grant permissions to others and change restaurant information. The software is secure and includes security features including encryption, two factor authentication, and is password protected.

As illustrated in FIG. 1, a user can add up to eight restaurants to his or her preferred list (which can be changed at any time). When a user orders food for pick up, the user chooses one of the eight restaurants and places an order. The order is displayed on the restaurant personnel application indicating there is a new order for a set time. The restaurant personnel can accept the order or update timing for the order which the user will be intimated of through application updates and SMS. The restaurant personnel app shows the current status of all orders for the day including new orders, reviewed orders, orders ready for pickup, completed orders and cancelled orders. The restaurant personnel can also update the orders in case the customer wishes to call and change anything in the order. The restaurant personnel also search for customers and place orders for them if they called on the phone, the application shows the customers last order and other customer information, to enable easy reorders. In certain embodiments, users may save their car information for curbside pickup. The application integrates the use of custom promotional codes to encourage customer loyalty. The restaurant personnel can search orders and are able to access different restaurant locations through a single account. Managers can use the application to approve access to new staff. The applications also include options to contact the service provider for support and look at the change log for an order. The orders are updated by personnel and the history of change is recorded and the customer is updated in real time what is the status of his order and receive notifications of when the order is ready for pickup.

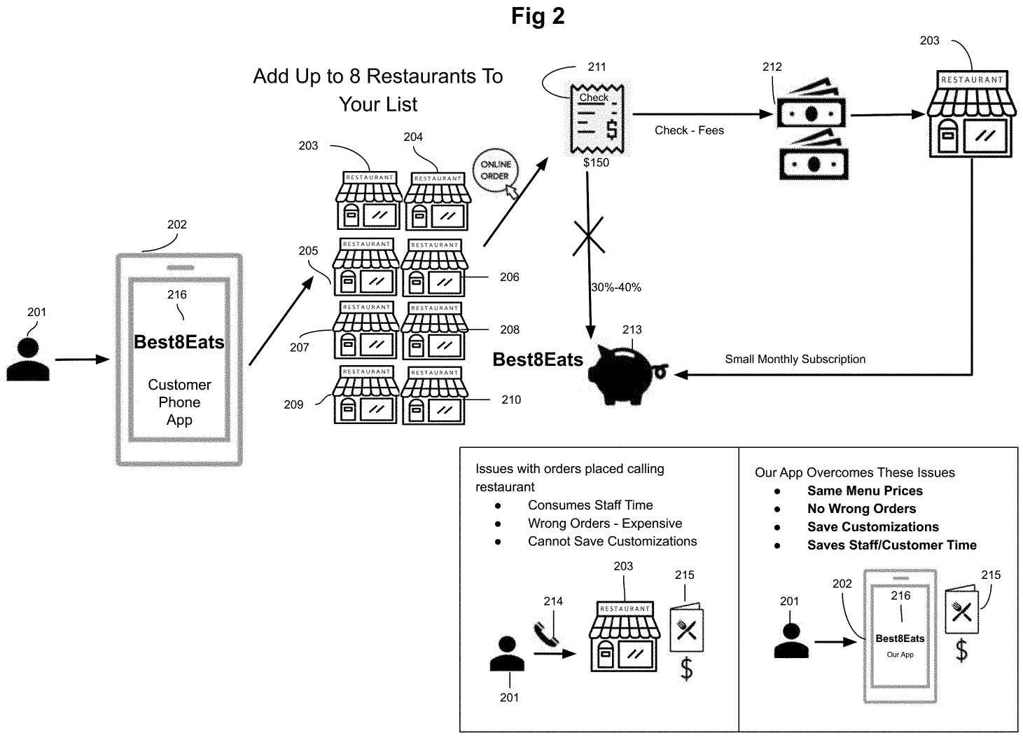

FIG. 2 illustrates an embodiment of a system, wherein a user pays a subscription fee to use the system. In this embodiment, a user 201, accesses a consumer application 216 with a smartphone 202. The user pays a monthly subscription fee. In contrast to services where a user pays a greater price, or service fees for each order, the user is able to place an unlimited number of orders at the restaurants selected as a user's favorites, for any month the subscription fee has been paid. The user may then place an order at any restaurant 203-210 selected as a favorite. The user pays the total for an order 211, the organization operating the service offering the system collects a fee 210, and the restaurant 203 receives the balance of the amount paid by the user. The user 201 is then able to pick up the order. This embodiment allows restaurant staff to spend less time taking orders, and because the orders are provided by each user, this reduces costs to the restaurant resulting from erroneous orders. Certain embodiments also list prices that are the same prices charged to restaurant customers dining in the restaurant.

In certain embodiments, restaurants pay for the use of the application by paying a fixed fee for a period of time. In other embodiments, users may pay a monthly subscription fee. Subscriptions for restaurants can be billed on a monthly or annual basis.

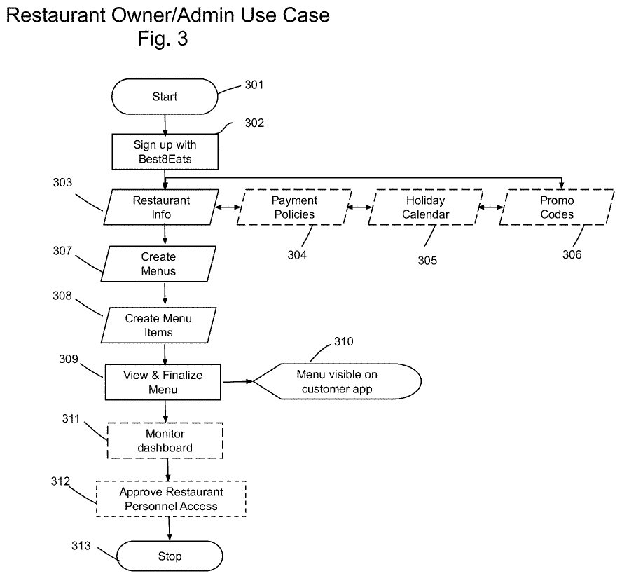

FIG. 3 illustrates a representative embodiment of a workflow used by restaurant personnel to establish a profile on the system. In order to start 301 the process, a restaurant creates an account with the service, illustrated as Best8Eats 302. The signup process may include separate accounts and user profiles for each restaurant employee or may include only a single profile for the restaurant. The restaurant personnel then enter restaurant information 303, which may include payment policies 304, holiday closings and hours 305, and promotional codes 306. Payment policies may include the ability for users to pay by credit card, debit card, crypto currency, cash, gift cards, or other payment methods. Restaurant personnel may create profiles for multiple locations, and may create different menus, pricing, hours, and other settings for each restaurant location. Restaurant personnel also create menus 307 and create individual menu items 308. A final menu is displayed and finalized after restaurant personnel approve the menu 309, and the menu is then displayed to users 310 on the system through applications or a web interface. Restaurant personnel are then able to monitor their dashboard 311, to view ongoing orders, and to track performance metrics. Restaurant personnel are also able to select other restaurant employees who will have access to the system 312, and to set permission levels for each employee.

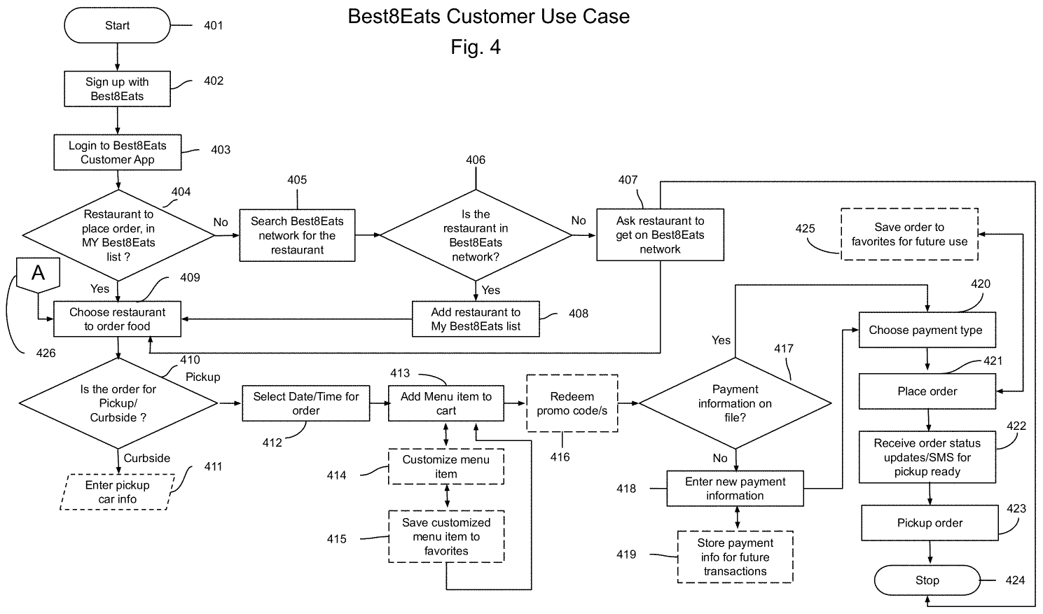

FIG. 4 illustrates a representative embodiment of a workflow used by a user to order food through the system. A user starts the process 401 by establishing an account with the service 402. The user logs into the consumer version of the application or access the service through a web interface 403. The user then provides demographic information such as name, phone number, address, email address, and stores one or more payment methods, such as credit cards, bank accounts, cryptocurrency accounts, or gift cards. The user also selects favorite restaurants when creating an account. When placing an order, the user, or the system, determines if the restaurant from which the user would like to order is on the user's existing list 404. If the restaurant is on the user's list of favorite restaurants, the user selects the restaurant 409, and indicates whether the order is for pickup inside the restaurant or curbside pickup 410. For curbside pickup, the user enters additional details such as the make, model, and color of the user's vehicle 411. The user then selects a date and time for the order 412, selects menu items to be added to the user's cart 413, and optionally, enters in any promotional codes 416 offered by the restaurant. The system then determines if a user has a payment method stored to the user's profile 417. If the user does not have a payment method on file, the user is prompted to provide the payment information 418, and the payment information is stored 419. The user is then prompted to select the payment type 420, and the order is placed 421. Both the user and restaurant are provided with status updates regarding the order 422. The restaurant receives a prompt that an order has been placed, and the system pay integrate with the restaurant's existing point-of-sale (POS) system. Users will receive updates via email and SMS test message, and will also receive updates through smartphone applications. Once the order is complete, the user will receive a notice that the order is ready for pickup, and the user will pick up the order 423. When a user is searching for restaurants to add to the user's list of favorites, if the restaurant is not part of the service's existing network of restaurants, a message may be sent to the restaurant via email, or SMS message, or any other method, asking the restaurant to join the network and establish an account 407.

A user using the application to order can also search for restaurants in the area and add to his list of favorite restaurants. When the user is ready to order, the user can either choose pickup or curbside delivery and indicate the car details in the application and order the food from the menu. In certain embodiments, users are only charged standard restaurant prices for orders made through the application. Each dish can be customized with the restaurant allowed customizations and with any additional notes pertaining to the order. Users are able to pay for orders with preselected payment methods, that have been previously stored. The application allows users to store any favorite dishes or orders for easy reordering. This functionality can eliminate wrong orders and saves users time. The application also features options to contact the service provider for support and contact the restaurant to provide any feedback.

Certain embodiments also integrate a point of sale terminal, that will integrate all functionality of the mobile application. Certain embodiments include functionality to allow restaurants to manage seating, reservations, and dine in orders. Other embodiments comprised integrations to use predictive analytics to aid restaurant personnel in maintaining adequate inventory, and determine adequate staffing at specific times and days. Such integrations may include artificial intelligence. Certain embodiments also include the ability to include wireless communication devices for restaurant staff.

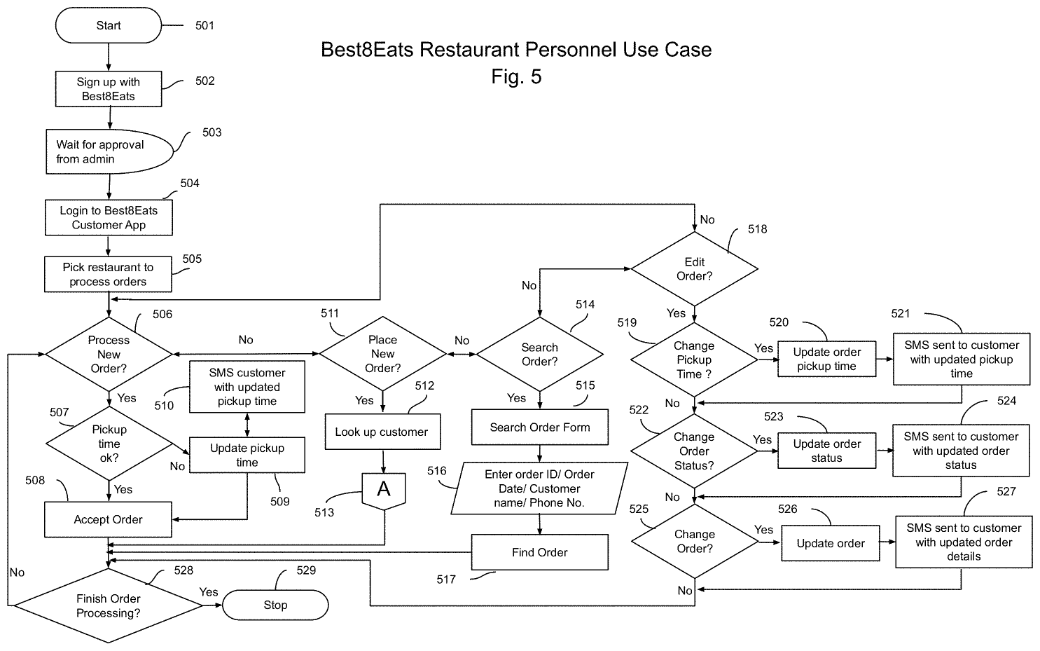

The system also allows for additional functionality to assist restaurant personnel in providing support to customers and revising orders, as needed. FIG. 5 illustrates a representative embodiment of use of the system by restaurant personnel. To start any use of the system 501, all restaurant personnel must have an account and establish access to the system 502. Once this account has been created, restaurant personnel having administrative level permissions will approve access to restaurant's profile to specified restaurant personnel 503. Once approved for access, restaurant personnel may log in to the restaurant's profile via the application, or web interface 504, and select the restaurants and locations at which they are working 505. When new orders arrive from a user 508, restaurant personnel will determine whether to accept and process the order. If the order is not accepted 528, the process ends for the restaurant and the user receives a notification that the order was not accepted. If the order is accepted, the restaurant personnel determine whether the pickup time is acceptable 507. If the pickup time is not acceptable, the pickup time is updated 509, and the user is notified via SMS text 510, email, or a notification through the application. Once the order is accepted, the order is prepared and the user is notified that is ready for pickup, and the order process is compete 528. If a restaurant declines to process the initial order, has the option to determine whether to initiate a new order 511. The restaurant may then search for a customer 512 and contact the customer directly 513. If a user contacts the restaurant regarding an order, the restaurant may search for an order 514. The restaurant may then use a search order interface 515 to locate the order and search by customer, order identification number, customer name, email address, or phone number 516. Once the order is found 517, the order may then be processed. Orders may also be edited 518. If an order is edited, the pickup time may be changed 519. If the pickup time is changed, the order pickup time is updated 520 and the user is notified via SMS text, email, or through the application 521. The status order may also be changed 525. If the status of the order is changed, restaurant personnel may update the status 523, and the user is notified via SMS text, email, or through the application 524. Additionally, restaurant personnel may change the order contents, or customizations to menu items 525. Changes to the order itself may be entered into the system by restaurant personnel by updating the order 526. The update to the order is then communicated to the user via SMS text, email, or through the application 527.

While the invention has been described and illustrated with reference to certain particular embodiments thereof, those skilled in the art will appreciate that the various adaptations, changes, modifications, substitutions, deletions, or additions or procedures and protocols may be made without departing from the spirit and scope of the invention. It is intended, therefore, that the invention be defined by the scope of the claims that follow and that such claims be interpreted as broadly as reasonable.

What is claimed is:

1. A system for online ordering comprising:
a network;
a computing device; and
computer readable media encoding instructions for practicing the method disclosed herein.

2. The methods for online ordering disclosed herein.
